(19) United States
(12) Patent Application Publication
(10) Pub. No.: US 2018/0066795 A1
(43) Pub. Date: Mar. 8, 2018

(54) LOW PRESSURE HIGH VOLUME GREASE GUN

(71) Applicant: Nathaniel C. Polley, Rangely, CO (US)

(72) Inventor: Nathaniel C. Polley, Rangely, CO (US)

(21) Appl. No.: 15/695,691

(22) Filed: Sep. 5, 2017

Related U.S. Application Data
(60) Provisional application No. 62/383,113, filed on Sep. 2, 2016.

(51) Int. Cl. F16N 3/12

(52) U.S. Cl. CPC F16N 3/12; F16N 13/08

(57) ABSTRACT

A grease gun which uses a piston to mechanically push grease from a standard tube without the need for air pressure. A grease tube chamber is sized to hold a standard tube of grease, and may be closed at a first or front end by a cap with a dispensing nozzle. At a second end, a piston assembly includes a plunger rod with a piston that may be advanced towards the front end by a drive handle assembly. As the piston advances, it enters into the open rear end of a grease tube, pushing the grease forward where it is dispensed through the nozzle on the cap. When not in use, the plunger rod is urged rearwards by a spring, pulling the piston away from the grease to reduce potential leakage.

### CROSS-REFERENCE TO RELATED APPLICATION

This application claims the benefit of U.S. Provisional Application No. 62/383,113, filed Sep. 2, 2016, the disclosure of which is incorporated herein by reference in its entirety.

### TECHNICAL FIELD

This invention relates to systems for dispensing grease for use in mechanical lubrication.

### BACKGROUND

Standard grease guns use relatively high pressure to liquefy grease held in a cardboard tube and then dispense it through a hose. The grease guns may be difficult to pump for use. Where a pressurized gun is stored, it can leak if the pressure is not released. As a result, where a user needs only to lubricate a small item, such as a single bearing or chain, it is often done by simply opening a tube of grease and applying the grease by hand. Since a grease tube is a simple cardboard cylinder with removable caps at both ends filled with grease, this can be a messy process. A low pressure grease gun that could be easily operated, stored and used without leakage would be an improvement in the art.

### SUMMARY

The present disclosure is directed to a grease gun that uses a piston to mechanically push grease from a standard tube without the need for air pressure which is simple to use. A grease tube chamber is sized to hold a standard tube of grease, and may be closed at a first or front end by a cap with a dispensing nozzle. At a second end, a piston assembly includes a plunger rod with a piston that may be advanced towards the front end by a drive handle assembly. As the piston advances, it enters into the open rear end of a grease tube, pushing the grease forward where it is dispensed through the nozzle on the cap. When not in use, the plunger rod is urged rearwards by a spring, pulling the piston away from the grease to reduce potential leakage.

### DESCRIPTION OF THE DRAWINGS

It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIGS. 1A and 1B depict the components of a grease gun assembly in accordance with the present disclosure in an assembled and unassembled condition.

FIG. 2 is an enlarged view of the piston and a portion of the assembly of FIGS. 1A and 1B, shown in relation to a standard grease tube for use.

FIG. 3 is an enlarged view of a portion of the dispensing cap and tube chamber of FIGS. 1A and 1B, shown in relation to a standard grease tube for use.

FIG. 4 depicts side and front views of different replaceable tips or nozzles useful with grease gun assemblies in accordance with the teachings of the present disclosure.

### DETAILED DESCRIPTION

The present disclosure relates to apparatus, systems and methods for dispensing grease through a mechanical action using low pressure. It will be appreciated by those skilled in the art that the embodiments herein described, while illustrative, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

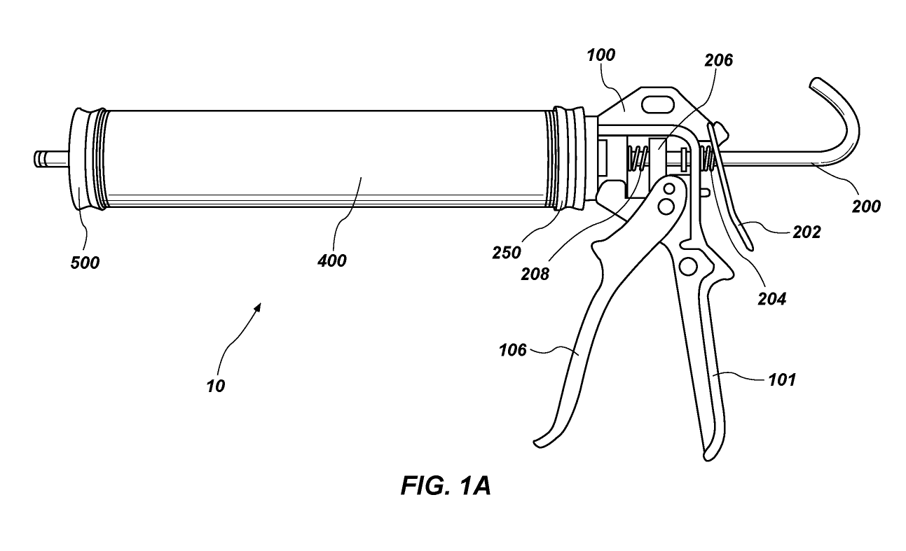

Turning to FIGS. 1A and 1B, the components for a grease gun assembly 10 that uses a piston to mechanically push grease from a standard tube without the need for air pressure which is simple to use are depicted. A grease tube chamber 400 is formed from a cylinder having an open bore. In the depicted embodiment, the chamber 400 has two opposite open ends, allowing it to be removed from the remainder of the assembly 10 for maintenance and cleaning. Near each end, the cylinder may include structures for attachment to other parts of the assembly 10, such as threads 404 and 402 disposed on the exterior surface adjacent the front and rear ends. It will be appreciated that on other alternative embodiments, it may have a single open front end and be permanently attached to the remainder of the assembly. It will be further appreciated that although threads 404 and 402 on the exterior surface are depicted, that any suitable interconnection structures may be used.

The grease tube chamber 400 is sized and configured to retain a standard grease tube within it. In one illustrative embodiment, the grease chamber may have a circular bore with an inside diameter of about 2 and 3/16 inches and a length of about 10 and ½ inches. It will be appreciated that the size and shape of the chamber 400 may vary to allow for use with different size and shapes of grease tubes.

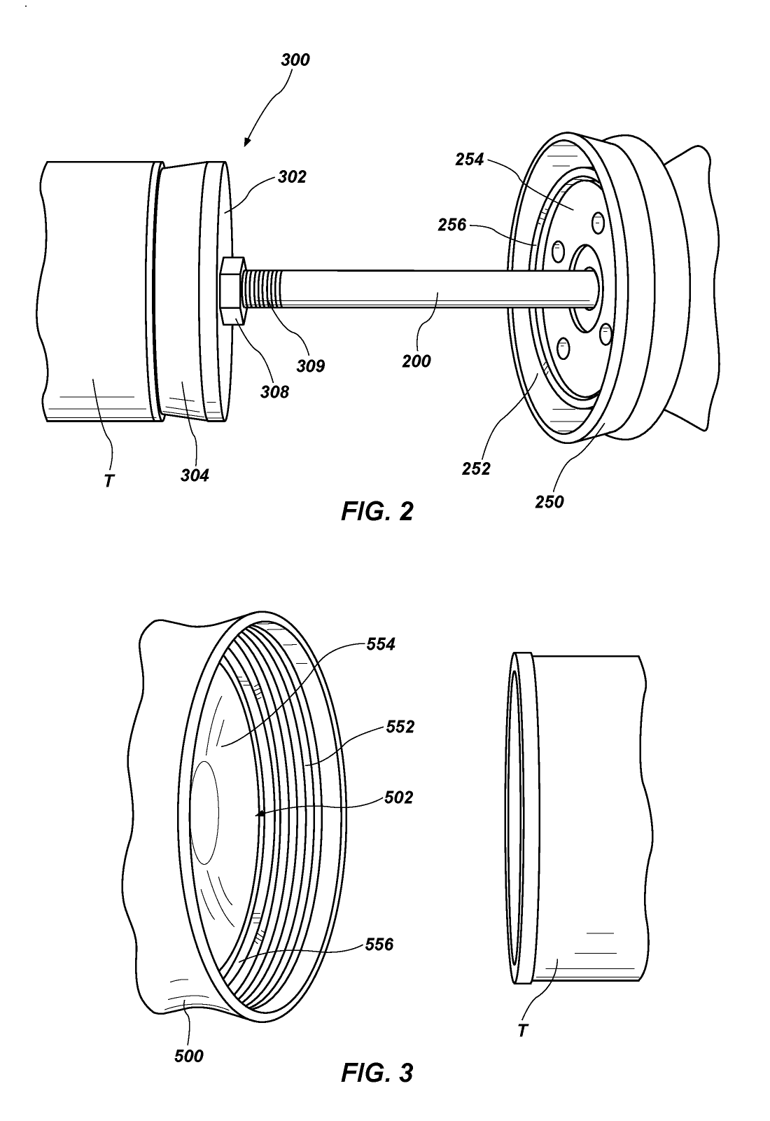

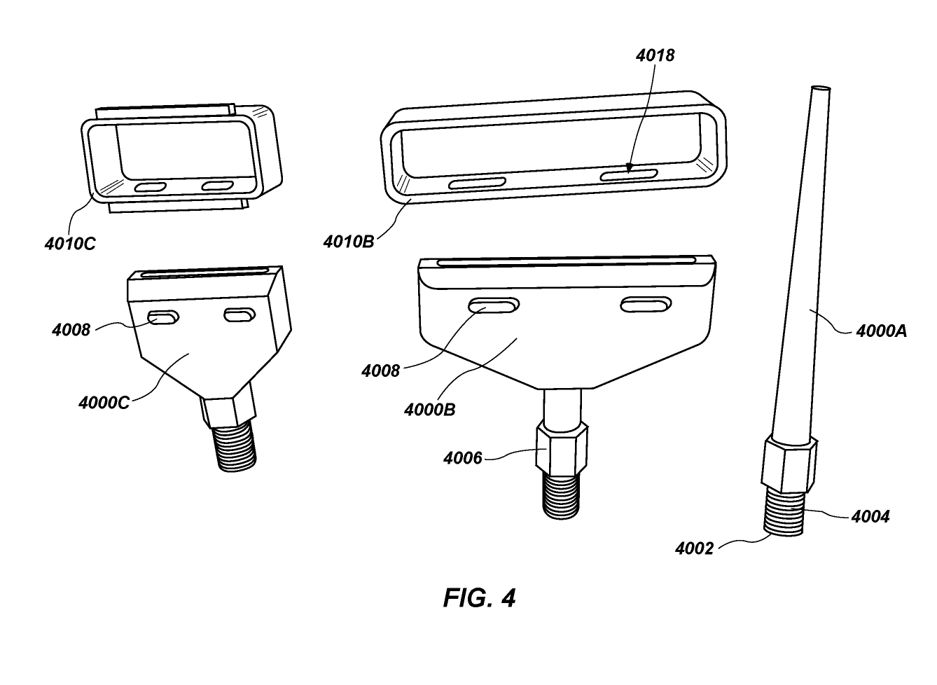

At a front end, the chamber 400 may be closed by attachment to a cap 500 which includes a dispensing nozzle 502. The relationship of the cap 500 to an inserted tube T of grease is best depicted in FIG. 3. In the depicted embodiment, this is accomplished by threading the cap over the end with threads 552 that interact with the threads 404 on the chamber 400. As depicted, the nozzle 502 may include a dispensing aperture and may be threaded or include ridges for attachment to dispensing tips having different shapes (such as a wider, rectangular opening for applying a thin film, or round openings of varying size for applying beads of grease), as discussed further herein with in connection with FIG. 4. Additionally, a closing cover or tip cap may be used to reduce the possibility of leakage. The interior front surface 554 of the cap 500 may be sloped towards the muzzle to facilitate flow of the grease thereover. A seal, such as an o-ring 556 is preferably disposed in cap 556 to seal with the front edge of the tube T upon installation, preventing grease from flowing around the tube T in the chamber 400.

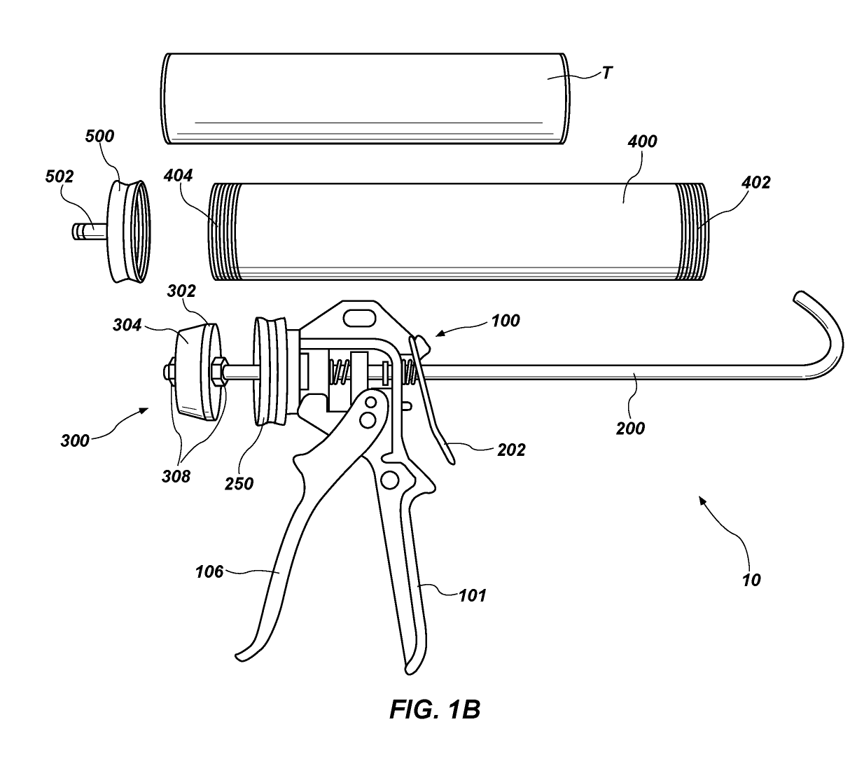

At a second, or rear, end the chamber 400 in the depicted embodiment may be attached to the drive 100 handle assembly. The drive handle assembly 100 includes a frame 101 for supporting the remaining components. In the depicted embodiment, a rear cap or chamber mounting component 250 is attached to the frame 101 with a forward projecting flange having threads 252 for attachment to the threads 402 on the chamber 400. As depicted in FIG. 2, the rear cap may include a central plate 254 which fits within the open rear end of a tube T and a seal, such as an o-ring 256 which may be placed around the central plate 254 to seal with the rear edge of the tube T upon installation, preventing grease from flowing around the tube T in the chamber 400.

Upon mounting, a plunger rod 200 extends through the frame 101 into the bore of chamber 400 with a piston assembly 300 disposed at the front end thereof. As depicted, the piston assembly 300 may be mounted on the plunger rod 200 by one or more mounting nuts 308 on a corresponding threaded portion 309, but it will be appreciated that any suitable mounting may be used. In the depicted embodiment, the piston assembly 300 includes a rear plate 302 formed of a stiffer material and a resilient front portion or plug 304. The front portion preferably includes a tapered sidewall and a planar front surface. As best depicted in FIG. 2, in use, the piston 300 is moved forward into the rear opening of a grease tube T. The resilient nature of the front portion 304 and its tapered sidewalls facilitate its insertion and allow it to compress against the walls of the tube T, moving the grease forward as the piston 300 is advanced.

Plunger rod 200 extends from piston assembly 300 through the frame 101 to a curved rear end and is associated with a drive assembly. The drive assembly includes springs 204 and 208, and release tab 202, and a ratchet mechanism 206, all associated with the plunger rod 200 and frame 101. Additionally, a trigger grip handle 106 is rotatably attached to the frame 101 for interaction with the ratchet mechanism and plunger rod to actuate the drive assembly. These components may be similar to those used on a standard caulking gun or other known drive mechanism for controlled advancement of a rod.

For use, once chamber 400 is secured in place on the frame (where removable), the release tab 202 is actuated and the plunger rod 200 is drawn backwards to the rearmost position. The top and bottom caps of a standard tube of grease are removed and the tube inserted into the chamber 400 bore. The front cap 500 is then attached, retaining the tube T in the chamber. A user then squeezes the trigger handle 106 to cause the rod 200 to move forward. The tube T is held in place by front cap 500 and the piston 300 enters the open rear end of the tube. As the piston 300 advances, grease is pushed forward from the tube and flows though nozzle 502 and any attached dispending nozzle for use. When the trigger handle 106 is released, pressure on the piston ceases and the flow of grease stops.

It will be appreciated that the various components may be constructed of materials of suitable strength that possess the necessary properties for their use as discussed herein. For example, the chamber, front cap, frame and associated components, including plunger rod and stiffening plate 302 may be formed from steel, steel alloys, and/or anodized aluminum alloys, as well as any other suitable materials. Similarly, the flexible portion of the piston may be formed from a suitable rubber or plastic material. It will be further appreciated that in addition to grease for mechanical use, the assembly of the present disclosure may be used for dispensing other materials of similar viscosity.

Turning to FIG. 4, several different replaceable tips 4000A, 4000B and 4000C for use with a system in accordance with the present disclosure are depicted. Each tip 4000A, B or C includes a connection portion 4002 near a proximal end thereof that includes threads 4004. Threads 4004 allow the tips to be connected to nozzle 502, in the depicted embodiment, the threads 4004 are external and connect to internal threads disposed inside the opening of the nozzle 502. It will be appreciated that in other embodiments, the threads 4004 may be disposed internally in the bore of the tips and the counterpart threads on the nozzle 502 disposed on an exterior surface of the nozzle. Additionally, in some embodiments, the nozzle 502 may be removably threaded into cap 500 and the various tips serve as different nozzles that may be releasably attached thereto. As depicted, each tip includes an internal bore that extends from an opening at the proximal end to a dispensing aperture at the distal end. The dispensing apertures may be different shapes, and the bores different sizes, as the depicted, rectangular opening for applying a thin or thick films, and round openings for applying beads of grease. Additionally, it will be appreciated that a closing cover or tip cap 40108 or 4010C may be used to close the respective tip 4000b or 400C to reduce the possibility of leakage when not in use. The closable tips may include locking tabs 4008 formed as raised protrusions on the exterior sidewalls thereof. Counterpart locking recesses 4018 may be disposed on the interior sidewalls of the caps, to retain the caps in place when placed thereon. The resilient nature of the material used to make the tips and caps, such as a plastic or metallic material may allow the parts to slightly flex as the caps are placed or removed to allow the locking tabs 4008 and recesses 4018 to removably interconnect or reverse as the caps are attached or detached.

While this disclosure has been described using certain embodiments, it can be further modified while keeping within its spirit and scope. This application is therefore intended to cover any variations, uses, or adaptations of the disclosure using its general principles. Further, this application is intended to cover such departures from the present disclosure as come within known or customary practices in the art to which it pertains and which fall within the limits of the appended claims.

What is claimed is:

1. A grease dispensing tool comprising:
a tube chamber having a closed distal end and an open front end for receiving a tube of grease;
a cap releasably attachable to the tube chamber over the open front end, the cap including a dispensing opening and a seal element for sealing against a tube of grease at an open front of the tube of grease;
a dispensing nozzle attached to the dispensing opening; and
a piston assembly comprising a piston sized to enter an open rear end of the grease tube while contacting sidewalls of the grease tube, a plunger rod connected to the piston and extending distally therefrom and a drive assembly for advancing or retracting the piston.

2. The tool of claim 1, wherein the tube chamber comprises a tube having a bore sized to retain a tube of grease.

3. The tool of claim 1, wherein the cap releasably attachable to the tube chamber over the open front end comprises a cap with a threaded connection portion that rotatably attaches to the tube chamber by threading on counterpart threads around the tube chamber to cover the open front end.

4. The tool of claim 1, wherein the cap including a dispensing opening comprises a cap with a centrally disposed dispensing opening and a curved inner surface sloping towards the centrally disposed dispensing opening.

5. The tool of claim 1, wherein the seal element for sealing against a tube of grease at an open front of the tube of grease comprises a seal disposed on an inner surface of the cap which contacts the front sidewall of the tube of grease retained in the tube chamber when the cap is attached to the tube chamber with the tube of grease disposed therein.

6. The tool of claim 5, wherein the seal element comprises an o-ring disposed in a groove on the inner surface of the cap.

7. The tool of claim 1, wherein the dispensing nozzle attached to the dispensing opening comprises an interchangeable nozzle that may be removed and replaced from the tool.

8. The tool of claim 1, wherein the piston sized to enter an open rear end of the grease tube while contacting sidewalls of the grease tube comprises a piston having a flexible front portion attached to a rear push plate.

9. The tool of claim 8, wherein the flexible front portion has a slanted sidewall tapering from a first diameter at a front surface to a smaller diameter at a rear surface adjacent the push plate.

10. The tool of claim 8, wherein the plunger rod is connected to the rear push plate.

11. The tool of claim 1, wherein the drive assembly for advancing or retracting the piston comprises a trigger handle for actuating the assembly, at least one spring configured to advance the plunger rod when the trigger handle is actuated and a ratchet mechanism to prevent rearward movement of the plunger rod when the trigger handle is not actuated.

12. The tool of claim 11, wherein the drive assembly for advancing or retracting the piston further comprises a release tab that may be actuated to remove the tension from the at least one spring from the plunger rod so the plunger rod may be drawn rearward.

13. A grease dispensing tool comprising:
a grease tube holder having distal end for sealing against a tube of grease at an open rear end of the tube of grease disposed therein and an open front end;
a cap releasably attachable to the grease tube holder to close the open front end thereof, the cap including a dispensing opening and a seal element for sealing against a tube of grease at an open front of the tube of grease;
a dispensing nozzle attached to the dispensing opening;
a piston assembly comprising a piston sized to enter an open rear end of the grease tube while contacting sidewalls of the grease tube, a plunger rod connected to the piston and extending distally therefrom; and
a drive assembly for advancing or retracting the piston comprising a trigger handle for actuating the assembly and at least one spring configured to advance the plunger rod when the trigger handle is actuated.

14. The tool of claim 13, wherein the drive assembly further comprises a ratchet mechanism to prevent rearward movement of the plunger rod when the trigger handle is not actuated.

15. The tool of claim 13, wherein the drive assembly for advancing or retracting the piston further comprises a release tab that may be actuated to remove the tension from the at least one spring from the plunger rod so the plunger rod may be drawn rearward.

16. The tool of claim 13, wherein a grease tube holder having distal end for sealing against a tube of grease at an open rear end of the tube of grease disposed therein comprises a grease tube holder having distal end with a seal disposed on an inner surface thereof which contacts a rear sidewall of the tube of grease retained in the grease tube holder when the tube of grease is disposed therein.

17. The tool of claim 13, wherein the seal element for sealing against a tube of grease at an open front of the tube of grease comprises a seal disposed on an inner surface of the cap which contacts the front sidewall of the tube of grease retained in the grease tube holder when the cap is attached to the grease tube holder with the tube of grease disposed therein.

18. The tool of claim 17, wherein the seal element comprises an o-ring disposed in a groove on the inner surface of the cap.

19. The tool of claim 13, wherein the piston sized to enter an open rear end of the grease tube while contacting sidewalls of the grease tube comprises a piston having a flexible front portion attached to a rear push plate.

20. The tool of claim 19, wherein the flexible front portion has a slanted sidewall tapering from a first diameter at a front surface to a smaller diameter at a rear surface adjacent the push plate.
